(19) United States
(12) Patent Application Publication
(10) Pub. No.: US 2026/0187572 A1
(43) Pub. Date: Jul. 2, 2026

(54) METHOD, DEVICE, TERMINAL AND STORAGE MEDIUM FOR INFORMATION PROCESSING

(71) Applicant: Beijing Feishu Technology Co., Ltd., Beijing (CN)

(72) Inventor: Jixue Lei, Beijing (CN)

(21) Appl. No.: 18/728,371

(22) PCT Filed: Jan. 6, 2023
(86) PCT No.: PCT/CN2023/071015

§ 371 Date: Jul. 11, 2024

(30) Foreign Application Priority Data
Jan. 11, 2022 (CN) 202210027744.7

(51) Int. Cl. G06Q 10/0639; G06F 3/0483; G06F 3/0484

(52) U.S. Cl. CPC G06Q 10/06398; G06F 3/0483; G06F 3/0484

(57) ABSTRACT

The present disclosure provides methods and devices, terminals and storage media for information processing. The method of information processing includes: displaying first evaluation information and second evaluation information on a first page; where the first page includes a first display area and a second display area, and the first display area displays the first evaluation information for predetermined user information, the second display area displays the second evaluation information for a predetermined user; in response to the triggering on the first display area in the first page, displaying the first task information in the display area of the first evaluation information.

### CROSS REFERENCE

The present application claims priority to Chinese Patent Application No. 202210027744.7 filed on Jan. 11, 2022, and entitled “METHOD, DEVICE, TERMINAL AND STORAGE MEDIUM FOR INFORMATION PROCESSING”, the entirety of which is incorporated herein by reference.

### FIELD

The present disclosure relates to the field of information technology, and specifically, to a method, a device, a terminal and a storage medium for information processing.

### BACKGROUND

In some performance appraisal systems, an appraisee is required to manually summarize his/her key work during the appraisal cycle, and subsequently an appraiser appraises the appraisee's work. This requires the appraisee to fill in his/her own summary of the relevant work, which is a heavy workload. Further improvements in this area are expected.

### SUMMARY

In order to solve the existing problems, the present disclosure provides a method, a device, a terminal and a storage medium for information processing.

This present disclosure utilizes the following technical solutions.

The embodiments of the present disclosure provide a method of information processing. The method of information processing comprises: displaying first evaluation information and second evaluation information on a first page; where the first page includes a first display area and a second display area, the first display area displays the first evaluation information for a predetermined user, and the second display area displays the second evaluation information for the predetermined user; and in response to triggering on the first display area in the first page, displaying first task information in a display area of the first evaluation information; where the first task information includes first level information and second level information, and the first level information and the second level information have an associated relationship in content; the first task information and the second evaluation information have an associated relationship in time.

Another embodiment of the present disclosure provides a device for information processing. The device for information processing comprises: a displaying module configured to display first evaluation information and second evaluation information on a first page; where the first page includes a first display area and a second display area, the first display area displays first evaluation information for a predetermined user, and the second display area displays second evaluation information for the predetermined user; the displaying module is further configured to display first task information in a display area of the first evaluation information in response to triggering on the first display area in the first page; where the first task information includes first level information and second level information, and the first level information and the second level information have an associated relationship in content; the first task information and the second evaluation information have an associated relationship in time.

In some embodiments, the present disclosure provides a terminal, comprising: at least one memory and at least one processor; where the at least one memory is configured to store program codes, and the at least one processor is configured to call the program codes stored in the at least one memory to perform the above method of information processing.

In some embodiments, the present disclosure provides a storage medium for storing program codes, the program codes being configured to perform the above method of information processing.

The embodiments of the present disclosure may provide corresponding reference information in the page of the evaluation system by displaying the first task information in a display area of the first evaluation information, the first task information and the second evaluation information having an associated relationship in time, which may eliminate the need to manually input the first task information and improve user convenience and efficiency of information processing.

### BRIEF DESCRIPTION OF THE DRAWINGS

The foregoing and other features, advantages, and aspects of various embodiments of the present disclosure will become more apparent in conjunction with the accompanying drawings and with reference to the following detailed implementations. Throughout the accompanying drawings, the same or similar reference numbers refer to the same or similar elements. It should be understood that the drawings are schematic, and that elements and elements are not necessarily drawn to scale.

FIG. 1 is a flow chart of a method of information processing according to an embodiment of the present disclosure.

FIG. 2 shows a schematic diagram of a first page according to some embodiments.

FIG. 3 shows a schematic diagram of a second page according to some embodiments.

FIG. 4 shows a schematic diagram of the second page according to some embodiments.

FIG. 5 shows a schematic diagram of the second page according to some embodiments.

FIG. 6 shows a schematic diagram of the second page according to some embodiments.

FIG. 7 shows a schematic diagram of the second page according to some embodiments.

FIG. 8 shows a schematic diagram of the second page according to some embodiments.

FIG. 9 shows partial modules for a device for information processing according to some embodiments of the present disclosure.

FIG. 10 is a schematic structural diagram of an electronic device according to embodiments of the present disclosure.

### DETAILED DESCRIPTION

Embodiments of the present disclosure will be described in more detail below with reference to the accompanying drawings. Although certain embodiments of the present disclosure are shown in the accompanying drawings, however it should be understood that the present disclosure may be implemented in various forms and should not be construed as being limited to the embodiments set forth herein, but rather these embodiments are provided for a more thorough and complete understanding of the present disclosure. It should be understood that the accompanying drawings and embodiments of the present disclosure are for exemplary purposes only and are not intended to limit the scope of the present disclosure.

It should be understood that the individual steps documented in the method embodiments of the present disclosure may be performed in parallel in accordance with “and/or”. Furthermore, the method embodiments may include additional steps and/or omit performing the illustrated steps. The scope of the present disclosure is not limited in this regard.

The term “include” and its variations, as used herein, are open-ended, i.e., “including, but not limited to.” The term “based on” means “based at least in part on”. The term “an embodiment” means “at least one embodiment”; the term “another embodiment” means “at least one further embodiment”; the term “some embodiments” means “at least some embodiments”. Relevant definitions of other terms will be given in the following description.

It should be noted that the concepts of “first”, “second” and/or the like mentioned in the present disclosure are only used to distinguish different devices, modules or units, and are not used to limit the order or interdependence of functions performed by these devices, modules or units.

It should be noted that the modification of “a” mentioned in the present disclosure is illustrative rather than limiting. Those skilled in the art will understand that unless the context clearly indicates otherwise, it should be understood as “one or more”.

The names of the messages or information interacted among the plurality of devices in the embodiments of the present disclosure are used for illustrative purposes only and are not intended to limit the scope of these messages or information.

In a current performance appraisal system, a user is required to manually summarize his/her key work during the appraisal cycle, and subsequent appraisals are based on this work summary, which makes the workload of the appraisee larger. In addition, currently in an objective task management (OKR, O: objective, KR: key result) system, the objective tasks may be summarized and reviewed. However, this information is not well referenced in the performance appraisal system. The present disclosure improves the convenience for users who use OKR to manage objects, by connecting the OKR review to the performance system through inter-system referencing.

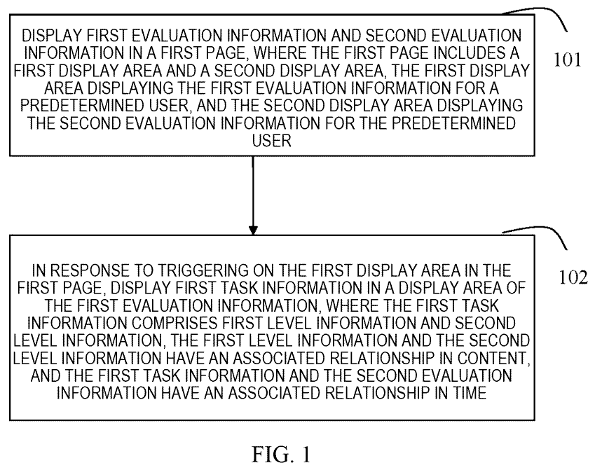

FIG. 1 provides a flowchart of a method of information processing according to an embodiment of the present disclosure. FIGS. 2 to 8 show schematic diagrams of display states of a first page or a second page according to some embodiments of the present disclosure. The method of information processing of the present disclosure may include step 101 of displaying first evaluation information and second evaluation information on a first page 11. In some embodiments, the first evaluation information includes, but is not limited to, the work content, self-evaluation, and/or the like of the appraisee. In some embodiments, the second evaluation information includes, but is not limited to, performance ratings, things done well and things to be improved, and/or the like.

In some embodiments, the first page 11 includes a first display area 12 and a second display area 13, the first display area 12 displays a first evaluation information for a predetermined user, and the second display area 13 displays a second evaluation information for the predetermined user. In some embodiments, the first page 11 is a display interface of the performance appraisal system, in which the performance appraiser may evaluate the work of the appraisee.

In some embodiments, the method of the present disclosure may further comprise step 102 of in response to triggering on the first display area 12 in the first page 11, displaying first task information 14 in a display area of the first evaluation information. In some embodiments, the first task information 14 may be displayed in a portion of the first display area 12. In some embodiments, the triggering include, but are not limited to, a click, a swipe, and/or the like.

In some embodiments, displaying the first task information in the display area of the first evaluation information comprises: switching the first evaluation information displayed in the display area to the first task information; or displaying both the first evaluation information and the first task information in the display area.

In some embodiments, the first task information 14 comprises first level information and second level information, and the first level information and the second level information have an associated relationship in content. In some embodiments, the first level information may be OKR content, with O representing objective task information, and KR representing key structure or subtask information. In some embodiments, the second level content may be a summary of the completion of the first level content, for example, the completion of the OKRs. In some embodiments, the first task information and the second evaluation information have an associated relationship in time. In some embodiments, the first task information generally precedes the second evaluation information. In some embodiments, the second evaluation information may be an evaluation of the first task information.

By displaying the first task information in the display area of the first evaluation information, where the first task information includes the first level information and the second level information, the first level information and the second level information have an associated relationship in content, and the first task information and the second evaluation information have an associated relationship in time, it may provide corresponding reference information (for example, the first task information) in a client or an application serving as the evaluation system, eliminating the need for manually input of the corresponding information and improving user convenience and efficiency of information processing. For example, in the performance appraisal, since the first task information generated in the OKR management system may be referenced in the performance appraisal system, the appraisee will no longer need to manually input the corresponding appraisal information into the performance appraisal system, and the appraiser may also see this information in the performance appraisal system and may appraise the appraisee with reference to this information. In this way, the need for the appraisee to input the corresponding information content is eliminated, which provides a great convenience.

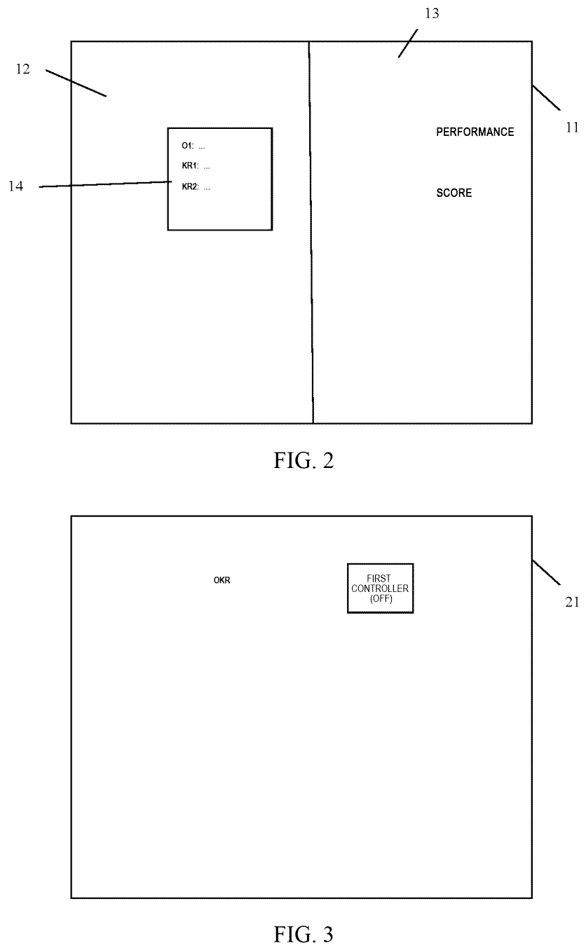

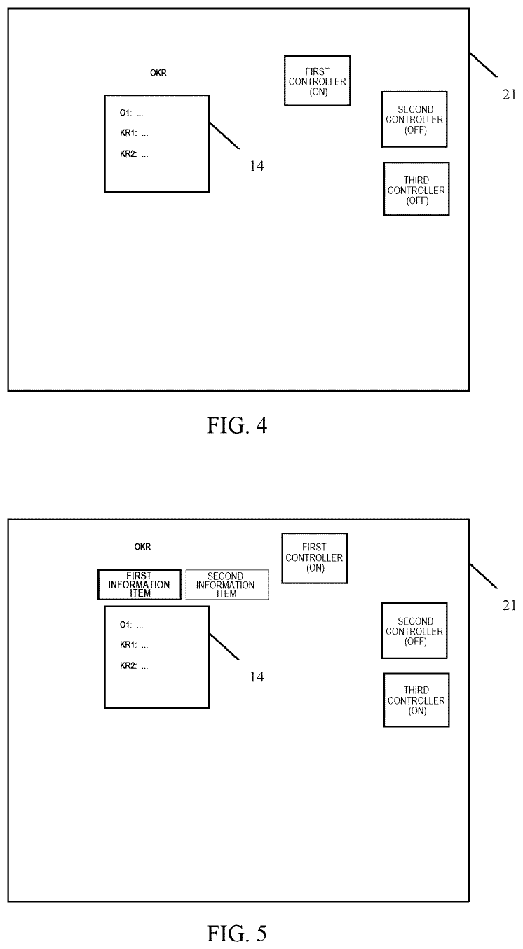

In some embodiments, the method of the present disclosure further comprises: controlling the first task information 14 to be hidden or displayed, according to triggering for the first controller in the second page 21. In some embodiments, the first controller may be a switch controller, including two states: on and off, but the present disclosure is not limited thereto. In some embodiments, the triggering for the first controller may be an appropriate operation such as a click, a swipe, or a voice command, and/or the like. For example, by clicking on the first controller, the first controller changes from the off state to the on state; by clicking on the first controller again, the first controller changes from the on state to the off state. In some embodiments, whether or not the first task information 14 is displayed or shown may be controlled through the first controller. As shown in FIG. 3, in a case that the first controller is closed, the second page 21 does not display the specific content of the first task information 14. At this time, the first task information 14 is also not displayed in the first display area 12 of the first page 11. As shown in FIG. 4, in a case that the first controller is turned on, the second page 21 displays the specific content of the first task information 14. At this time, the first task information 14 is displayed in the first display area 12 of the first page 11.

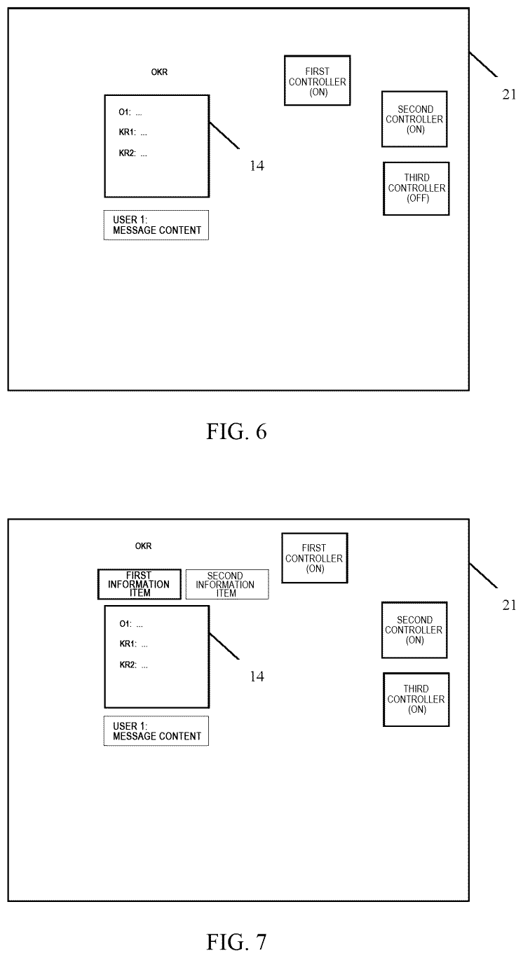

In some embodiments, the method of the present disclosure further comprises: in response to controlling the first task information 14 to be displayed, controlling comment information associated with the first task information 14 to be hidden or displayed, according to triggering for the second controller in the second page 21. In some embodiments, similar to the first controller, the second controller may be a switch controller, including two states: on and off, but the present disclosure is not limited thereto. In some embodiments, the triggering for the second controller may be an appropriate operation, such as a click, a swipe, or a voice command and/or the like. For example, by clicking on the second controller, the second controller changes from the off state to the on state; by clicking on the second controller again, the second controller changes from the on state to the off state. As shown in FIG. 6, in a case that the second controller is turned on, the comment information associated with the first task information 14 includes the content of message comment of user 1. In this way, the user may control comments of the first task information to be displayed or hidden. In some embodiments, the second controller may be turned on for viewing, in a case that the appraiser of the performance appraisal system expects to view comments from other users or colleagues on the first task information.

In some embodiments, the method of the present disclosure further comprises: in response to controlling the first task information 14 to be displayed, controlling a second level information to be hidden or displayed, according to triggering for the third controller in the second page 21. In some embodiments, similar to the first controller, the third controller may be a switch control, including two states: on and off, but the present disclosure is not limited thereto. In some embodiments, the triggering for the third controller may be an appropriate operation, such as a click, a swipe, or a voice command and/or the like. For example, by clicking on the third controller, the third controller changes from the off state to the on state; by clicking on the third controller again, the third controller changes from the on state to the off state. As shown in FIG. 5, in a case that the third controller is turned on, a first information item corresponding to the first level information and a second information item corresponding to the second level information are displayed. In some embodiments, in a case that the third control is turned off, only the first level information of the first task information 14 is displayed, neither displaying the second level information, nor displaying the first information item corresponding to the first level information or the second information item corresponding to the second level information, as shown in FIG. 4.

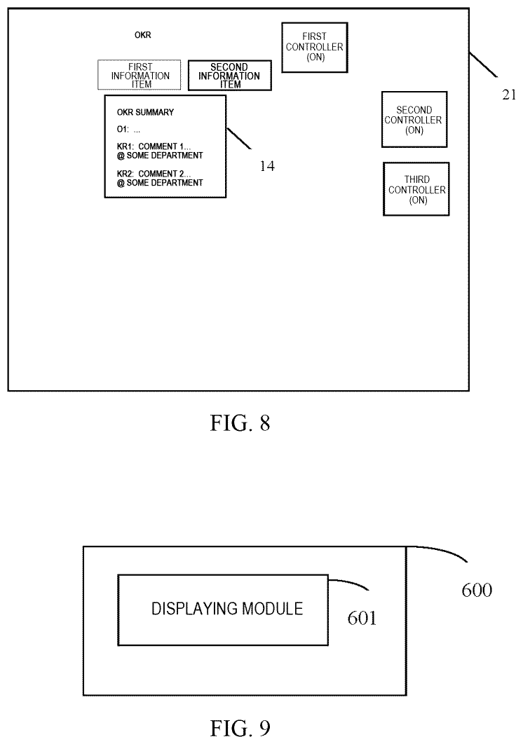

In some embodiments, in a case that the first level information is displayed in the first display area 12, the first information item corresponding to the first level information is highlighted, as shown in FIG. 7. In some embodiments, in a case that the second level information is displayed in the first display area, the second information item corresponding to the second level information is highlighted, as shown in FIG. 8. That is, the first level information corresponds to the first information item, and the second level information corresponds to the second information item. In this way, only one of the first level information and the second level information is displayed in the first page 11 at the same time, saving the display space of the first display area 12. It should be understood that while FIGS. 7 and 8 show display states of the first task information in the second page 21, the first task information in the first page 11 is also displayed in the same manner. For example, in the second page 21, in a case that the first information item is highlighted, the first information item is also highlighted in the first page 11. In some embodiments, the first page 11 is a content display page, and the second page 21 is a background function control page.

In some embodiments, displaying the first task information in the display area of the first evaluation information comprises: embedding a collaborative document into the display area, and displaying the first task information in the collaborative document. In some embodiments, for example, OKR system information is embedded into the evaluation and appraisal system in the form of a collaborative document, so that the first task information may be viewed in the form of a collaborative document in the first page 11 of the evaluation and appraisal system. Here, the collaborative document is a document that may be accessed and collaboratively edited by multiple people at the same time, including but not limited to an online document, a shared document, a cloud document, and/or the like.

In some embodiments, in the collaborative document embedded in the display area, the main content is displayed and other content areas except the main content area are hidden. Other content areas may include at least one of a function setting controller area at the top, a table of contents area at the left, a comment area at the right and an interactive area at the bottom.

In some embodiments, the first task information is hidden in response to a current user having no access right to the collaborative document. That is, whether the first task information 14 is displayed on the first page 11 of the corresponding client depends on whether the client has reading right for the first task information 14. If the client haves no reading right for the first task information 14, the first task information 14 will not be displayed on the first page 11. In this way, users without reading right may be prevented from viewing the first task information 14, and the privacy setting of the first task information 14 is protected.

In some embodiments, in response to the current user having no access right to the collaborative document, a fourth controller for obtaining the access right to the collaborative document is displayed. In some embodiments, the fourth controller is the controller that determines whether access is requested. By triggering for the fourth control, the permission manager may be requested for the view right of the collaborative document.

In some embodiments, in response to the current user obtaining access to the collaborative document, the display area is refreshed to display the first task information 14. As described above, if the client has no read right for the first task information 14, the first task information 14 will not be displayed in the first page 11. When the client obtains the read right for the first task information 14 by applying permission, the first task information 14 may be displayed in the first page 11 at this time.

In some embodiments, OKRs may have different OKRs in different times, and the appraisal period may be larger than the corresponding individual OKR period. In some embodiments, there are corresponding options on the first page to view OKR-related content for multiple OKR periods, enabling reference to information about a plurality of OKRs within the performance appraisal period during the performance appraisal.

Embodiments of the present disclosure also provide an information processing device 600. The information processing device 600 includes a displaying module 601. In some embodiments, the displaying module 601 is configured to display first evaluation information and second evaluation information in a first page; where the first page includes a first display area and a second display area, the first display area displays first evaluation information for a predetermined user, and the second display area displays second evaluation information for the predetermined user; the displaying module is further configured to display first task information in a display area of the first evaluation information in respond to triggering on the first display area in the first page; where the first task information includes first level information and second level information, and the first level information and the second level information have an associated relationship in content; the first task information and the second evaluation information have an associated relationship in time.

It should be understood that the content described with respect to the information processing method is also applicable herein for the information processing device 600, which is not described in detail herein for the purpose of simplicity.

In some embodiments, the information processing device further comprises: a control module configured to control the first task information to be hide or display, according to triggering for a first controller on a second page. In some embodiments, the control module is also configured to in response to controlling the first task information to be displayed, controlling comment information associated with the first task information to be hidden or displayed, according to triggering for a second controller in the second page. In some embodiments, the control module is also configured to in response to controlling the first task information to be displayed, controlling the second level information to be hidden or displayed, according to triggering on a third controller in the second page. In some embodiments, in a case that the first level information is displayed in the first display area, a first information item corresponding to the first level information is highlighted; in a case that the second level information is displayed in the first display area, a second information item corresponding to the second level information is highlighted. In some embodiments, displaying the first task information in the display area of the first evaluation information comprises: embedding a collaborative document into the display area, and displaying the first task information in the collaborative document. In some embodiments, the control module is also configured to hide the first task information in response to a current user having no access right to the collaborative document; or the display module is also configured to display a fourth controller in response to the current user having no access right to the collaborative document, the fourth controller being used to obtain the access right to the collaborative document. In some embodiments, the displaying module is also configured to in response to the current user obtaining the access right to the collaborative document, refresh the display area and display the first task information.

In addition, the present disclosure also provides a terminal, comprising: at least one memory and at least one processor; where the at least one memory is configured to store program codes, and the at least one processor is configured to call the program codes stored in the at least one memory to execute the above method of information processing.

In addition, the present disclosure also provides a computer storage medium for storing program codes, the program codes being configured to execute the above method of information processing.

The information processing method and device for the present disclosure are described above based on embodiments and application examples. In addition, the present disclosure also provides a terminal and a storage medium, which are described below.

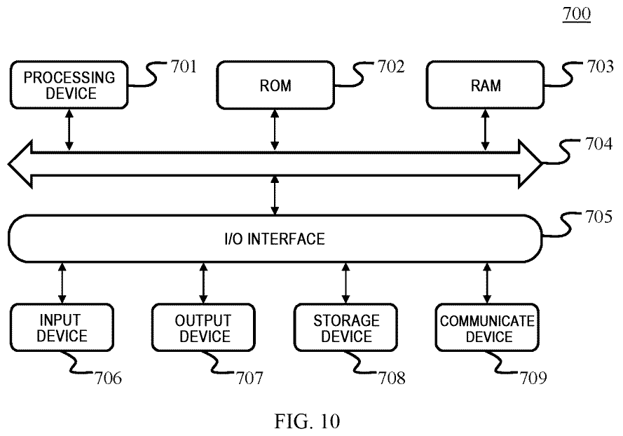

Referring now to FIG. 10, which illustrates a schematic structural diagram of an electronic device (eg, terminal device or server) 700 suitable for implementing embodiments of the present disclosure is shown. Terminal devices in embodiments of the present disclosure may include, but are not limited to, mobile terminals such as mobile phones, laptop, digital broadcast receivers, PDAs (personal digital assistants), PADs (tablet computers), PMPs (portable multimedia players), vehicle-mounted terminals (for example vehicle-mounted navigation terminals) and/or the like, as well as fixed terminals such as digital TVs, desktop computers, and/or the like. The electronic device shown in FIG. 10 is only an example and it should not impose any limitations on the functions and usage scope of the embodiments of the present disclosure.

As shown in FIG. 10, the electronic device 700 may include a processing device (for example, a central processor, a graphics processor, etc.) 701, which may perform various appropriate actions and processes based on a program stored in a read-only memory (ROM) 702 or a program loaded from a storage device 708 into a random access memory (RAM) 703. In the RAM 703, various programs and data required for the operation of the electronic device 700 are also stored. The processing device 701, the ROM 702 and the RAM 703 are connected to each other via a bus 704. An input/output (I/O) interface 705 is also connected to the bus 704.

Generally, the following devices may be connected to the I/O interface 705: an input device 706 including, for example, a touch screen, a touch pad, a keyboard, a mouse, a camera, a microphone, an accelerometer, a gyroscope, and/or the like; an output device 707 including, for example, a liquid crystal display (LCD), a speaker, a vibration, and/or the like; a storage device 708 including, for example, a magnetic tape, a hard disk, and/or the like; and a communication device 709. The communication device 709 may allow the electronic device 700 to communicate in a wireless or wired way with other devices to exchange data. While FIG. 10 illustrates the electronic device 700 with various devices, it should be understood that it is not required to implement or have all of the illustrated devices. More or fewer devices may alternatively be implemented or provided.

In particular, according to embodiments of the present disclosure, the processes described above with reference to the flowcharts may be implemented as computer software programs. For example, embodiments of the present disclosure include a computer program product comprising a computer program carried on a computer-readable medium, the computer program comprising program codes for executing the method shown in the flowchart. In such embodiments, the computer program may be downloaded and installed from the network via a communication device 709, or from a storage device 708, or from a ROM 702. When the computer program is executed by the processing device 701, the above-mentioned functions defined in the method of embodiments of the present disclosure are performed.

It should be noted that the computer readable medium mentioned above in the present disclosure may be a computer readable signal medium or a computer readable storage medium, or any combination of the above. The computer readable storage medium may be, for example, but is not limited to, a system, a apparatus or a device of electricity, magnetism, light, electromagnetism, infrared, or semiconductor, or any combination of the above. More specific examples of computer readable storage media may include, but are not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer readable storage medium may be any tangible medium containing or storing a program that may be used by or in combination with an instruction execution system, apparatus, or device. In the present disclosure, however, a computer readable signal medium may include a data signal propagated in baseband or as part of a carrier, carrying computer readable program codes therein. Such propagated data signals may take a variety of forms, including but not limited to a electromagnetic signal, an optical signal, or any suitable combination of the above. A computer readable signal medium may also be any computer readable medium other than a computer readable storage medium that may send, propagate, or transmit a program for use by or in combination with an instruction execution system, apparatus, or device. Program codes embodied on a computer readable medium may be transmitted using any suitable medium, including but not limited to: wire, optical fiber cable, RF (radio frequency), and/or the like, or any suitable combination of the above.

In some implementations, the client and server may communicate using any currently known or future developed network protocol such as HTTP (HyperText Transfer Protocol), and may be interconnected with digital data communications (e.g., communication networks) of any form or medium. Examples of communication networks include local area networks (“LANs”), wide area networks (“WANs”), inter-networks (e.g., the Internet), and end-to-end networks (e.g., ad hoc end-to-end networks), as well as any currently known or developed in the future networks.

The above-mentioned computer readable medium may be included in the above-mentioned electronic device; it may also exist independently without being assembled into the electronic device.

The above-mentioned computer readable medium carries one or more programs, when the above-mentioned one or more programs are executed by the electronic device, cause the electronic device to perform the above-mentioned method of the present disclosure.

Computer program codes for performing the operations of the present disclosure may be written in one or more programming languages, including object-oriented programming languages such as Java, Smalltalk, C++, and conventional procedural programming language-such as “C” or similar programming languages. The program codes may be executed entirely on the user computer, and partially on the user computer, as a stand-alone software package, partially on the user computer and partially on a remote computer or entirely on the remote computer or server. In the case involving a remote computer, the remote computer may be connected to the user computer through any kind of network, including a local area network (LAN) or a wide area network (WAN), or it may be connected to an external computer (for example, by utilizing an Internet service provider to connect via the Internet).

The flowcharts and block diagrams in the accompanying drawings illustrate the architecture, functionality, and operation of systems, methods, and computer program products that may be implemented in accordance with various embodiments of the present disclosure. At this point, each block in the flowchart or block diagram may represent a module, a program segment, or a portion of codes that contains one or more executable instructions for implementing a specified logical function. It should also be noted that, in some alternative implementations, the functions labeled in the block may also occur in a different order than those labeled in the accompanying drawings. For example, two consecutively blocks represented may actually be executed substantially in parallel, or they may sometimes be executed in the reverse order, depending on the function involved. It is also be noted that each block of the block diagram and/or flowchart, and combinations of blocks in the block diagram and/or flowchart, may be implemented with a specialized hardware-based system that performs the specified function or operation, or may be implemented with a combination of specialized hardware and computer instructions.

The units involved in the embodiments described in the present disclosure may be implemented in software or hardware, where the name of a unit does not constitute a limitation on the unit itself under certain circumstances.

The functions described above herein may be performed, at least in part, by one or more hardware logic components. For example, non-limitingly, exemplary types of hardware logic components that may be used include: Field Programmable Gate Arrays (FPGAs), Application-Specific Integrated Circuits (ASICs), Application-Specific Standard Products (ASSPs), Systems on Chips (SOCs), Complex Programmable Logical device (CPLD) and on the like.

In the context of the present disclosure, a machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus or devices, or any suitable combination of the above. More specific examples of machine-readable storage medium would include electrical connections based on one or more wires, a portable computer disk, a hard disk, a random access memory (RAM), a read-only memory (ROM), an erasable programmable read-only memory (EPROM or flash memory), an optical fiber, a portable computer disk read-only memory (CD-ROM), an optical storage device, a magnetic storage device, or any suitable combination of the above.

According to one or more embodiments of the present disclosure, an information processing method is provided. The method of information processing comprises: displaying first evaluation information and second evaluation information in a first page; where the first page includes a first display area and a second display area, the first display area displays the first evaluation information for a predetermined user, and the second display area displays the second evaluation information for the predetermined user; in response to triggering on the first display area in the first page, displaying first task information in a display area of the first evaluation information; where the first task information includes first level information and second level information, and the first level information and the second level information have an associated relationship in content; the first task information and the second evaluation information have an associated relationship in time.

According to one or more embodiments of the present disclosure, the method of information processing further comprises: controlling the first task information to be hidden or displayed, according to triggering on a first controller in the second page.

According to one or more embodiments of the present disclosure, the method of information processing further comprises: in response to controlling the first task information to be displayed, controlling comment information associated with the first task information to be hidden or displayed, according to triggering for a second controller in the second page.

According to one or more embodiments of the present disclosure, the method of information processing further comprises: in response to controlling the first task information to be displayed, controlling the second level information to be hidden or displayed, according to triggering on a third controller in the second page.

According to one or more embodiments of the present disclosure, when the first level information is displayed in the first display area, and a first information item corresponding to the first level information is highlighted; when the second level information is displayed in the display area, and the second information item corresponding to the second level information is highlighted.

According to one or more embodiments of the present disclosure, displaying the first task information in the display area of the first evaluation information comprises: embedding a collaborative document into the display area, and displaying the first task information in the collaborative document.

According to one or more embodiments of the present disclosure, the first task information is hidden in response to a current user having no access right to the collaborative document; or a fourth controller for obtaining the access right to the collaborative document is displayed in response to the current user having no access right to the collaborative document.

According to one or more embodiments of the present disclosure, the display area is refreshed to display the first task information, in response to the current user obtaining the access right to the collaborative document.

According to one or more embodiments of the present disclosure, an information processing device is provided. The device of information processing comprises: a displaying module configured to display first evaluation information and second evaluation information in a first page; where the first page includes a first display area and a second display area, the first display area displays first evaluation information for a predetermined user, and the second display area displays second evaluation information for the predetermined user; the displaying module is further configured to display first task information in a display area of the first evaluation information in response to triggering on the first display area in the first page; where the first task information includes first level information and second level information, and the first level information and the second level information have an associated relationship in content; the first task information and the second evaluation information have an associated relationship in time.

According to one or more embodiments of the present disclosure, a terminal is provided, comprising: at least one memory and at least one processor; where the at least one memory is configured to store program codes, and the at least one processor is configured to call the program codes stored in the at least one memory to execute the above method of information processing.

According to one or more embodiments of the present disclosure, a storage medium is provided, the storage medium for storing program codes, and the program codes being configured to execute the above method.

The above description is only a preferred embodiment of the present disclosure and an illustration of the technical principles used. It should be understood by those skilled in the art that the scope of disclosure involved in the present disclosure is not limited to technical solutions formed by a particular combination of the above technical features, but also should cover solutions formed by any combination of the above technical features or without departing from the above disclosed concept. For example, a technical solution formed by interchanging the above features with technical features with similar functions disclosed in the present disclosure (but not limited to).

Furthermore, although the operations are depicted in a specific order, this should not be understood as requiring that these operations be performed in the specific order shown or performed in a sequential order. In certain circumstances, multitasking and parallel processing may be advantageous. Similarly, while several specific implementation details are included in the above discussion, these should not be construed as limiting the scope of the present disclosure. Certain features described in the context of individual embodiments may also be implemented in combination in a single embodiment. Conversely, various features described in the context of a single embodiment may also be implemented in multiple embodiments, either individually or in any suitable sub-combination.

Although the present subject matter has been described using language specific to structural features and/or methodological logical actions, it should be understood that the subject matter defined in the accompanying CLAIMS is not necessarily limited to the specific features or actions described above. Rather, the specific features and actions described above are merely example forms of implementing claims.

1. A method of information processing, comprising:
displaying first evaluation information and second evaluation information on a first page;
wherein the first page includes a first display area and a second display area, the first display area displays the first evaluation information for a predetermined user, and the second display area displays the second evaluation information for the predetermined user; and
in response to triggering on the first display area in the first page, displaying first task information in a display area of the first evaluation information;
wherein the first task information includes first level information and second level information, and the first level information and the second level information have an associated relationship in content; the first task information and the second level evaluation information have an associated relationship in time.

2. The method of information processing according to claim 1, further comprising:
controlling the first task information to be hidden or displayed, according to triggering for a first controller on a second page.

3. The method of information processing according to claim 2, further comprising:
in response to controlling the first task information to be displayed, controlling comment information associated with the first task information to be hidden or displayed, according to triggering for a second controller in the second page.

4. The method of information processing according to claim 2, further comprising:
in response to controlling the first task information to be displayed, controlling the second level information to be hidden or displayed, according to triggering on a third controller in the second page.

5. The method of information processing according to claim 1, wherein
the first level information is displayed in the first display area, and a first information item corresponding to the first level information is highlighted; and
the second level information is displayed in the first display area, and a second information item corresponding to the second level information is highlighted.

6. The method of information processing according to claim 1, wherein displaying the first task information in the display area of the first evaluation information comprises:
embedding a collaborative document into the display area; and
displaying the first task information in the collaborative document.

7. The method of information processing according to claim 6, wherein
the first task information is hidden in response to a current user having no access right to the collaborative document; or
a fourth controller for obtaining the access right to the collaborative document is displayed in response to the current user having no access right to the collaborative document.

8. The method of information processing according to claim 7, wherein the display area is refreshed to display the first task information, in response to the current user obtaining the access right to the collaborative document.

9. (canceled)

10. A terminal comprises:
at least one memory and at least one processor;
wherein the at least one memory is configured to store program codes, and the at least one processor is configured to call the program codes stored in the at least one memory to perform acts comprising:
displaying first evaluation information and second evaluation information on a first page;
wherein the first page includes a first display area and a second display area, the first display area displays the first evaluation information for a predetermined user, and the second display area displays the second evaluation information for the predetermined user; and
in response to triggering on the first display area in the first page, displaying first task information in a display area of the first evaluation information;
wherein the first task information includes first level information and second level information, and the first level information and the second level information have an associated relationship in content; the first task information and the second level evaluation information have an associated relationship in time.

11. A non-transitory storage medium for storing program codes, the program codes being configured to perform acts comprising:
displaying first evaluation information and second evaluation information on a first page;
wherein the first page includes a first display area and a second display area, the first display area displays the first evaluation information for a predetermined user, and the second display area displays the second evaluation information for the predetermined user; and
in response to triggering on the first display area in the first page, displaying first task information in a display area of the first evaluation information;
wherein the first task information includes first level information and second level information, and the first level information and the second level information have an associated relationship in content; the first task information and the second level evaluation information have an associated relationship in time.

12. The terminal according to claim 10, wherein the acts further comprises:
controlling the first task information to be hidden or displayed, according to triggering for a first controller on a second page.

13. The terminal according to claim 12, wherein the acts further comprises:
in response to controlling the first task information to be displayed, controlling comment information associated with the first task information to be hidden or displayed, according to triggering for a second controller in the second page.

14. The terminal according to claim 13, wherein the acts further comprises:
in response to controlling the first task information to be displayed, controlling the second level information to be hidden or displayed, according to triggering on a third controller in the second page.

15. The terminal according to claim 11, wherein
the first level information is displayed in the first display area, and a first information item corresponding to the first level information is highlighted; and
the second level information is displayed in the first display area, and a second information item corresponding to the second level information is highlighted.

16. The terminal according to claim 11, wherein displaying the first task information in the display area of the first evaluation information comprises:
embedding a collaborative document into the display area; and
displaying the first task information in the collaborative document.

17. The terminal according to claim 16, wherein
the first task information is hidden in response to a current user having no access right to the collaborative document; or
a fourth controller for obtaining the access right to the collaborative document is displayed in response to the current user having no access right to the collaborative document.

18. The terminal according to claim 17, wherein the display area is refreshed to display the first task information, in response to the current user obtaining the access right to the collaborative document.

19. The non-transitory storage medium according to claim 11, wherein the acts further comprises:
controlling the first task information to be hidden or displayed, according to triggering for a first controller on a second page.

20. The non-transitory storage medium according to claim 19, wherein the acts further comprises:
in response to controlling the first task information to be displayed, controlling comment information associated with the first task information to be hidden or displayed, according to triggering for a second controller in the second page.

21. The non-transitory storage medium according to claim 20, wherein the acts further comprises:
in response to controlling the first task information to be displayed, controlling the second level information to be hidden or displayed, according to triggering on a third controller in the second page.
